(19) United States
(12) Patent Application Publication
(10) Pub. No.: US 2004/0117451 A1
(43) Pub. Date: Jun. 17, 2004

(54) Methods and systems for electronic mail internet target and direct marketing and electronic mail banner

(76) Inventor: Michael Myung-Jin Chung, Bayside, NY (US)

Correspondence Address: Michael Chung, 211 35 23rd Avenue #1F, Bayside, NY, 11360, US

(21) Appl. No.: 10/472,413

(22) PCT Filed: Mar. 22, 2002
(86) PCT No.: PCT/US02/08832

(51) Int. Cl. G06F 15/16

(52) U.S. Cl. 709/207

(57) ABSTRACT

Methods and systems for: special standards, code sets and handling for specially identifying electronic mail (“email”) in a self-contained, electronic mail system, including the sorted routing and exclusive delivery of such identified email to their designated destination client folders/interfaces or other special handling, while filtering other non-identifiable electronic mails from its routing and delivery network; also, methods and systems for direct mailing and marketing on the Internet, including, using names and addresses list(s) or demo-graphic database(s) to match to, or extract, or append the matched names and addresses' electronic mail or targetable IP addresses from the subscriber and customer database(s) or list(s) of the respective electronic mail and Internet service providers; and a graphics-banner style email “banner” for electronic mail; and other Internet marketing and electronic mail methods and systems.

### CROSS-REFERENCE TO RELATED APPLICATIONS

This application claims priority to the provisional application No. 60/277,651, filed on Mar. 22, 2001, and provisional application No. 60/322,454, filed on Sep. 17, 2001 both which are incorporated by reference in their entirety herein.

### FIELD OF INVENTION

The invention is in the areas of: electronic mail (email) systems, email address and database merging, mapping and appending; and also the areas of Internet advertisements and marketing.

### BACKGROUND AND OVERVIEW OF THE INVENTION

The invention provides for a variety of systems and methods for email and online marketing. It includes systems and methods for a self-contained email system where the access, routing, delivery and the display of email are completely controlled and blocked to un-authorized emails and users. It implements distinguishing system for individual email and/or their senders based on pre-determined standards, and code sets. It will enable the delivery of such email through special routing and displaying procedures. The invention's email system can be seen as a “proprietary” email system over Internet email transport system, where additional proprietary standards and code sets are used to distinguish and to provide special handling for its emails from the general emails. The email distinguishing methods will be used for a variety of types of emails—such as opt-in or permission-based emails in order to route them to their respective “opt-in” destination folders or interfaces. In addition to the current art's routing methods, its emails will have at least one other layer or level of pre-determined identification and handling means and standards, between the sender and the destination email client, other than the target recipient's email address. The standards, code sets and the destination folders can be proprietary to the system provider. Additionally, the unauthorized use of such standards, code sets and destination folders can be deemed to be trespassing and theft of services.

The invention's email address appending, mapping methods and systems include data merging and mapping between the traditional direct marketing/mail demographic databases and customer lists with the subscriber databases of email and Internet service providers (collectively ISP). It will also allow the “reverse” mapping and appending of multiple demographic profiles and values to the subscribers of the ISPs by using demographic lists (aka direct marketing or direct mail lists).

Also, the invention provides a “graphic-banner style email” display to be used in place of the current art “text based email” header. It will enable colors, pictures, rich texts and images to be displayed.

The invention may be implemented in hardware or software, or a combination of both. Ideally, the invention is implemented in programs executed on programmable computers, each comprising a processor, a data storage system (including volatile and non-volatile memory and/or storage elements), and at least one input device, and one output device. Program code is applied to input data to perform the functions described and generate output information. The output information is applied to one or more output devices, in known fashion.

Such computer program is preferably stored on a storage media or device (e.g., ROM or magnetic diskette) readable by a general or special purpose programmable computer. The inventive system may also be considered to be implemented as a computer-readable storage medium, configured with a computer program, where the storage medium so configured causes a computer to operate in a specific and predefined manner to perform the functions described herein.

A number of embodiments of the present invention have been described. Nevertheless, it will be understood that various modifications may be made without departing from the spirit and scope of the invention. Accordingly, it is to be understood that the invention is not to be limited by the specific illustrated embodiments.

The invention disclosure is organized in segments, the reader can appreciate that the some of the methods and systems provided in their respective segments can be stand alone or used together.

Background of Electronic Mail Systems and Methods

Imagine if all the daily postal mail was aggregated and delivered to the recipient in “single envelope”—i.e. where the personal correspondences, bills, subscriptions, junk mail—was not separately packages but in a single aggregate envelope addressed personally to the recipient. Among others problems, it would be a great inconvenience to sort the various mails and the recipient may feel a greater inconvenience from the junk mail. In a way, the current single email inbox system and the open delivery platform (to anyone with the recipient's address) is similar to this “single envelope”.

The current arts provide blocking, filtering or guarding the existing delivery channels and the destination email folder. Instead, the invention creates “defacto” separate delivery channel(s) and destination folder(s) that are by default controlled access, delivery and usage. Thus it provides control over what “can't be controlled” (e.g. “spam”) by controlling what can be controlled, i.e. the emails of the “legitimate” senders.

A current art. “Email Filtering: Email filters scan incoming messages using specified criteria (specified by you), automatically performing various actions such as sorting your email into different folders, forwarding particular messages on to your friends, and more. A word of warning: Email filters are powerful tools if implemented properly—and an easy way to lose email if used carelessly, so tread carefully! As an example of the sort of thing one can accomplish using filters, the following instructions walk you through setting up filters to catch email tagged as spam by our Email Delivery Lizard. The Lizard tags suspected spam email with special additional email-headers so that we can easily notice them and filter accordingly.” Source: http://www.dnai.com/helpdesk/mailandnews/email_filtering/.

Still other current arts are:

U.S. Pat. No. 6,167,435. “Double opt-in.TM. method and system for verifying subscriptions to information distribution services.” “When a subscription request for a particular subscriber address is received, a unique token associated with the address is generated and a verification message containing the token is sent to the designated subscription e-mail address.”

U.S. Pat. No. 6,052,709. “Apparatus and method for controlling delivery of unsolicited email where one or more spam probe e-mail addresses are created and planted at various sites on the emails network in order to insure their inclusion on large-scale electronic junk mail (“spam”) mailing lists.”

U.S. Pat. No. 6,199,102. “The present invention provides a system and method for filtering unsolicited electronic commercial messages.”

U.S. Pat. No. 6,112,227. “A method is provided for preventing the delivery of unwanted email messages to a destination client.”

Additional related information excerpted from a www.businessweek.com series on email, Mar. 18, 2002:

“NO TRICKS. Spam and porn mail are also under increasing attack by legitimate e-mail marketers. The Direct Marketing Assn., an industry trade group, adopted new rules in late January that require all marketing e-mail to contain a special character that can serve as a unique identifier. The new rule is aimed at screening out spammers and creating an easy way for receiving companies to identify legitimate e-mail.”

“And it goes beyond companies enforcing policies that require an employee's in-box to be emptied after a set period of time. Rather, businesses are now looking to software that can allow users to designate several folders as untouchable—and that can wipe out the rest of their e-mail after a certain period. Likewise, e-mail marketers are looking to create registries of legitimate operations that will keep spammers—theoretically, at least—out of much of the U.S. e-mail system.”

“. . . But whether the problem is junk or volume, the result is the same: More and more, people like—who gets more than 100 e-mail messages each day—are tuning out even pitches they might want to see, from companies that asked permission to send them mail.”

“ROBUST GROWTH. “It's an issue we as an industry need to deal with,” says Michael Mayor, president and COO of leading e-mail marketing-list provider NetCreations. “Making your message stand out among the hundreds of other messages that are out there will become more and more of a challenge.””

“It's only going to get worse. Jupiter Media Metrix estimates that each Internet user received 571 spam messages in 2001. By 2006, it expects that number to rise to 1,500.”

“For ISPs, who are on the front line in the battle against spam, the costs are even higher. An ISP with 1 million customers will lose more than $6 million annually in revenues due to higher churn and increased customer acquisition costs to replace those it loses, according to a 1999 report from market researcher Gartner. Add to that $500,000 for new hardware, software, and personnel dedicated to the war against spam. According to a 2001 European Union study, Spam's costs now total about $8.6 billion a year worldwide.”

“There's some reason for optimism over the long run. Ferris of Ferris Research says five years down the road, a key weapon in the war on spam could be digital signatures. These electronic passports verify that the message you're receiving is actually from the person the message says it's from. Sooner rather than later, Ferris predicts, corporations and savvy users won't accept mail from senders without a digital signature: “People with a good reason to contact me should be able to identify themselves,” he says. “If someone won't tell me who he is, he's probably a dishonorable person.”” End of excerpts.

Also, there have been . . . “attempts to make laws so that every piece of spam would have to contain a specific pieces of information in the message header identifying it as unsolicited”. Although new guidelines and regulations may be created, it seems that it is impossible to prevent unsolicited commercial bulk email or force the use of spam identifiers.

Other proposed solutions suggest use of identifiers to tag emails. Examples are articles published in Direct Marketing News Aug. 16, 2001—a marketer, “called for a consortium of e-mail newsletter publishers and messaging service providers to open a dialog with Hotmail, Yahoo and AOL to work on a way to distinguish between unwanted bulk mail and opt-in newsletters. The (marketer) suggested the e-mail providers could provide some sort of “registered mail” code that can be used, which would flag opt-in mail and pass it to subscribers' inboxes.”

Also, the Direct Marketing Assn., the largest industry trade group for the direct marketing industry in USA, adopted new rules in late January (2002) that require all marketing e-mail to contain a special character that can serve as a unique identifier. The new rule is aimed at screening out spammers and creating an easy way for receiving companies to identify legitimate e-mail. Also, in the same release, the Direct Marketing Assn. “allow for sending e-mail to customers who, though they have done business through other channels, may have not given permission for electronic contact”—it did not mention how these email addresses will be acquired, since to date, one can argue that the act of voluntarily offering an email address was giving permission for its use, further mapping of the businesses' customer names and addresses list to an opt-in email list is not very reliable and the opt-in email lists often lack accurate street addresses. The invention includes these solutions and goes further by providing separate destination folders and being able to distinguish and handle emails based on specific subjects, categories and senders. The invention also includes method for encrypting and authenticating the code set, tags and other such distinguishing means in order to prevent or reduce the likelihood of non-authorized use of its standards and code set.

Some of the problems solved by the invention include addressing the growing volume of general emails and providing for systems and methods for distinguishing and separating certain emails and its senders from general email. Another problem solved is proposing use of such system to route un-solicited commercial bulk email (“spam”) or also known as direct solicitation emails, from “legitimate” advertisers to special designated destination folders.

It is an objective of the invention to provide method and systems for unique code set or standards for email system, to be used between the originator and the destination delivery service in order to recognize and specially handle certain emails and senders distinct from other general email not using such code set and standards.

It is an objective of the invention to provide method and systems for creating—standards and code set for emails based on pre-determined subject, categories or any other properties—to be used between the originators of email and destination email systems. Multiple senders and multiple destination email systems can use such standards and code set or specific to one destination email system.

It is an objective of the invention to provide method and systems for creating and inserting unique code set into emails, and providing the special handling of such emails including the routing to special destination folders

It is an objective of the invention to provide method and systems for an email system over the Internet that is accessible to only senders and their emails using the system's code sets and standards.

It is an objective of the invention to provide system and method for multiple levels of code set, tagging or coding systems in order to provision for a variety of instructions for the handling and routing of the emails.

It is an objective of the invention to provide method and systems for subject, category or sender specific destination folders.

It is an objective of the invention to provide method and systems, for the invention's user folders and interfaces to be located, including, in the email client menu bar, browser bar, on the subscriber's home or portal page; if on the interactive TV systems—then on the electronic program guide screen, email client screen, accessible from a dedicated key on the remote control; also to include wireless email and Internet access devices.

It is an object of the invention for system and method to have a separate receiving and displaying folder or interface for opted-in and permission-based emails using its code set.

It is an object of the invention for system and method to have a separate receiving and displaying folder or interface for unsolicited (or direct solicitation) commercial broadcasted or targeted emails using its code set.

It is an object of the invention for system and method to have its programs and applications installed by the email and Internet service providers on their proprietary local and web user interfaces—such as local and web email clients, portal pages, etc. However, an end user can separately install the invention's applications.

It is an object of the invention for system and method for a destination folder that will be the depository of all emails that are not bearing its unique code set or identifier, and not a sender's address that is in the recipient's contact directory or a database containing the all the recipient's “sent to” email addresses. Such folder can be deemed to be “UnRecognized” folder. Such folder can further be partitioned for unrecognized bulk sent mails and non-bulk sent mails.

It is another objective of this invention to use copyrighting protection for the viewable code set, codes and tags that are inserted in the email body in order that a non-authorized copier and user of such code set will be in violation of copyright laws.

It is another objective of this invention to use authentication and/or encryption systems in order to further differentiate and protect its code set or standards from unauthorized use.

Above and other objectives are disclosed in this document. These and other objects of the invention will be apparent to those skilled in the art from the following detailed description of the invention, the accompanying drawings and the appended claims.

Background of Online Target and Direct E-Mailing/Marketing

There are a variety of service and solutions, offline and online used by businesses to direct market to the public. Among these the traditional direct marketing channels and its demographic (direct marketing/mail) databases are most used and depended upon by small to large businesses. Direct marketing via the email channel requires, the acquisition or appending of email addresses—currently these are acquired in a one by one process. The invention addresses the difficulty of the traditional demographic profile databases, which lacks email addresses, to be used for online direct marketing. The invention also addresses the current deficiencies for the acquisition and appending of email addresses.

The century old, traditional or offline direct marketing industry in USA has certain advantages to their online or the Internet data gathering counterparts. This includes the more objective and concrete data gathering and profiling methods. “Every time the consumers provide their name and address to buy or receive a product or service, there's a good chance they are being added to one or more mailing lists. When they buy d car, move to a new address, have a baby, make a purchase from a catalog, give money to a charity or fill out a product registration card, their names is likely to be entered into a computer data base.”

These data can be made available through categories lists. For instance there are companies that track and house information (over 200 distinct data fields) on a reported 90% of all of the 100M households in the United States. A leading direct marketing list service provider in USA estimates that there are over 20,000 business and consumer categories and over 30,000 original list sources. These specialty lists are acquired from trade directories, governmental sources, and proprietary sources. They sell this data to businesses so that companies can build a complete view of their customers and prospects. These also can be sorted by Standard Industrial Classification (SIC) codes. Strict privacy standards need to be adhered to by these companies (and all companies accumulating data) to stay compliant with local and federal laws protecting the privacy of consumers. Generally, list brokers compile the lists from their owners and make them available to potential users of such lists on a one-time rental basis.

Some of the Sources for Demographic Data:

“MAIL ORDER, CREDIT CARDS AND MAGAZINES. A customer of one mail order company is likely to receive offers from other companies. Many mail order firms “rent” their mailing list to other businesses. Credit card companies also rent their mailing lists, as do magazines. So, a subscriber to a cooking magazine may find themselves receiving mail order catalogs for kitchen supplies and food specialties.

CREDIT BUREAUS. Companies with which consumers do business provide data to credit bureaus on how much they owe and how promptly bills are paid. While many credit bureaus rent lists, they do not disclose specific information such as what is owed or to whom. Rather, they compile lists based on consumer characteristics. An example would be a list of people with incomes over $40,000, who use credit cards and pay their bills on time. If a consumer falls into a category such as this, they might receive “pre-approved” credit card offers in the mail.

FLYERS AND ADVERTISING SUPPLEMENTS The most common types of unsolicited mail are the packets of advertising flyers that are delivered to mailboxes each week. They are addressed to “resident” and usually contain ads for local businesses like pizza parlors and auto repair services.” Etc.

The traditional demographic data lists are offered on the following types forms: 3×5 cards, 4—up Cheshire, Barcode, BBS/Email, CD Rom, Diskette, Gallery, P/S Labels, Mag Tape, Presort. A rate for usage/rental of a list might be $75 CPM (cost per thousand); or $150 CPM for one year unlimited usage. Further selections, within the category, by gender, title, geographics, age, etc. is generally available at additional costs. (Dunhills.com).

Also it reportedly costs $0.50 to $11 to separately acquire an email address. Without the email address, the traditional demographic database cannot be used for online marketing. The current ways to acquire email addresses are generally through opt-in or permission—based channels. These methods acquire the email addresses by a manual process, using printed mailers, or sign up areas online. Another drawback of such acquisition is that, email addresses in general are subject to more frequent changes. On the other hand the subscriber databases of the Internet service providers are 100% accurate and “freely pre-appended” to the names and addresses database of the subscribers or customer of the email and Internet service providers.

Other than location demographic, the email and the Internet service providers do not have the other demographic values of their subscribers—such as age, economic, psychographics, etc. The one common element in their data fields that will allow these databases to be merged and mapped is the names and the postal address of the demographic (direct marketing/mail) databases and the names and billing addresses of the subscribers and customer of the Email and Internet service providers. By use of such mapping—concise demographic targeting, profiling and delivery can be achieved to every online household that has provided their postal/billing address to an email or Internet service providers. The invention enable the unique “signature properties” of the two databases to fill the data lacking in the other to result in a “third” data that contains demographic values as well as online delivery channel addresses. Therefore the invention enables the most reliable and accurate sources of the demographic database(s) to be used with the most accurate and complete email address database(s).

The inventor is not aware of any current art that makes use of database(s) of subscribers of email and Internet service providers for email address appending purposes, especially for such use by non-related entities for purpose of direct marketing and further on computer systems with automated processes. To date, the businesses, advertisers and the marketers in the Internet industry have focused on acquiring email addresses only through the opt-in or permission-basis. Thus they had “no need” for any subscriber database mapping systems, because even if the email addresses were appended, the current proscription against usage of non—opt-in or pennission-based—would have prevent them from using such. Therefore for the “present art” industry, the email addresses were not the issue, it was the obtaining the permission, and thus they use a “manual” and itemized acquisition and appending process for each email address. The invention reverses the opt-in process, that's why the invention presumes to be able to use this method to “automatically” append electronic email addresses.

Also, assuming the email and Internet access services may provide mapping to their subscriber databases, it is extremely unlikely that they will allow the advertiser or even an intermediary broker to access to the actual email addresses. The email addresses would be too easy to copy and be absconded. Therefore the invention provides methods for the Email and Internet service providers to completely secure or guard their subscriber email addresses and yet allow matching and targeted delivery.

Some of the current arts are the traditional direct marketing industry's demographic direct mail lists of individuals and businesses. The demographic categories are segmented by subject and categories. For example, a direct marketing/mail directory's “Business Response List” has hundreds of subject and categories, with each further segmented more finely. For example, under “Architecture”, there are segments topics ranging from “American Institute of Architects Members” (52,850 individual targets) to “John Wiley & Sons Inc. Architecture Book Buyers” (27,110 individual targets). The geographic demographic values are a second demographic value of such lists by default. Other arts are the more recent, opt-in or permission-based lists where the database and the demographic categories are set up substantially the same as the traditional list, except that instead of the names, portal addresses and telephone numbers of the individuals, an email address is provided. These lists do not generally have the names and addresses associated with the email addresses. The demographic data available through the opt-in or permission-based lists can be seen to be more subjective as they generally are voluntarily provided information. Also, Valpak.com™ allows one to enter their geographic information (e.g. zip code) at their web site. Then they display the zip code based offerings. Each listing is placed by categories such as: Auto and Transportation, Beauty and Fitness, Entertainment and Leisure, etc.

Still another art is the U.S. Pat. No. 6,070,147—“Customer identification and marketing analysis systems”, where—“Rather than using privately-issued loyalty marketing program cards, (it) uses a government identification card that the vast majority of the population has with them at all times.”

Still another current art for online direct marketing and delivery channels is: U.S. Pat. No. 6.167,435. “Double opt-in™ method and system for verifying subscriptions to information distribution services.” “When a subscription request for a particular subscriber address is received, a unique token associated with the address is generated and a verification message containing the token is sent to the designated subscription e-mail address.” Another current art is U.S. Pat. No. 5,796,395. “System for publishing and searching interests of individuals”.

Still another current art, United States Patent Application-20020002590. “The present invention is a system and method for routing e-mails based on the recipient's physical address. The system includes an e-mail server that contains a database that maps physical addresses to e-mail addresses of users.”

It is an objective of the invention to provide for a system and method that matches a names and addresses list or demographic category(s) to one or more subscriber or customer databases of Email and Internet service providers in order to cause the delivery of emails to the matched names and addresses.

It is an objective of the invention to provide for a system and method for the uploading of names and addresses list to database containing the subscriber database(s) of the Email and Internet service providers, to provide the automated matching and mapping, then providing the outputting and the results.

It is an objective of the invention to provide for a system and method where a user uploads or selects and existing names and addresses list, then selects one or more of the available subscriber database(s) of the Email and Internet service providers, then the system to automatically batch or send the names and addresses list to the selected provider(s), then complete the mapping the outputting and then returning such result to the user.

Above and other objectives are disclosed in this document. These and other objects of the invention will be apparent to those skilled in the art from the following detailed description of the invention, the accompanying drawings and the appended claims.

Summary of Electronic Mail Methods and Systems

In order to propose some order and management to the current email system, the invention will create differentiation to its emails by providing unique standards and code sets and identifying methods used between cooperating senders and the destination email systems. The code set can provide a variety of information to the system. Such as that it is carrying such a code set, so as to distinguish from those that are not, then the subject or the category of the email in order to be further routed or handled per the system's standards and rules, such as to their respective destination, subject specific folders. Non-authorized or non-identified senders and emails, whether or not they have the recipients' email addresses will not be able to effectuate the delivery of their email via the invention's Deliverable Network and its destination folders.

A variety of methods and systems can be used for the code sets. These include, using special sending domains or uniquely modifying the destination email addresses; tagging or coding placed in the email. The email originating system (or an intermediary or proxy) will insert or use the code set and the routing and the destination email clients will have the reciprocal recognition and handling systems. A variety of methods and systems can be used for the filters, routers and identifiers of the special emails bearing such code set; and further a variety of methods and systems for the destination display interface and folders can be provided.

Consumers are faced with increasing volume of emails. Sometimes they may have difficulty distinguishing the opted-in or permission-based emails from those that are not. The invention's code set will permit automatic sorting schemes for certain pre-determined categories of email, from opted-in and permission emails—bills, subscriptions, to direct solicitations, etc.

The invention's special code set, handling and displaying methods and systems are for a self-contained and controlled-access email system that operates over the public Internet. Generally speaking, the current email filtering and blocking arts are based on an open or reactive system, that is, they react to the email and the senders addresses, certain “key” words in the email and based on these methods, attempt to filter, block or route them. Instead, the invention is controlled or a proactive system, where the senders and the recipients actively use standards and code sets pre-created and pre-agreed upon between the senders and the operators of the respective destination email systems, or by an intermediary or proxy, to differentiate their email and themselves from the general emails and senders. The special handling includes, designated destination client folders based on pre-determined categories. For example, “Bills” folder for bills and invoice related emails, “Subscription” folder for news and subscriptions, “Ads” folder for advertisements—which can further be segmented to “Local Ads” and “National Ads”—also Local Ads folder can be further segmented to “Supermarket”, “Restaurants”, “Priority” or “Express” folder—for a class of emails that are to be deemed high priority, etc.

Every email using the invention special code set and standards can be uniquely identified and specially handled and delivered. Emails not bearing its code set and not using its standards will be blocked from its destination delivery even if the sender has the email address of the targeted recipient. While in a preferred embodiment, the present invention routes its emails to their designated destination folders, the system can lead to many other practical applications. For example a one sender to one receiver identifier and foldering system can be set up; or individual code set for the individual categories in a demographic (direct marketing/mail) list rental directory. These also can be identified and sorted by Standard Industrial Codes (SIC), trade specific code and categories. For example, a medical doctor, may have a folder that is specially dedicated to a medical specialty, the emails from multiple unknown senders using such code set will be delivered to that folder, regardless of the sender's address.

The invention can also be used intranet. For example a large company uses the invention on their own internal network. It can create a specific “customer x” or “project x” email folder on each approved user's destination client. This can be used to automatically route all customer x related email to its specific folder. The folder can become a communal folder and shared among the authorized users. Another use of such is that all email with such identifier can be stored separately and retrieved regardless of the originating party.

An analogy for invention's designated destination foldering system. What if, the traditional Postal Mail Service and the Mailman set up a new system of compartmentalized mail delivery boxes for all the households in their Deliverable Network, where the mail boxes will have separate designated destination compartments for certain major categories of mail: personal mail, subscriptions, bills, and advertisements, and further where the postal service will automatically sort the mail based on these categories. Then the recipients can go to each compartment at their leisure, where the advertisements are saved until the recipients are ready and interested in viewing them. This is not practical offline, however the invention system will provide such for email.

The invention can set up one specific destination client category folder or permit a host of varieties. If one category folder, it can be for direct solicitations. For example, all direct marketing emails originating the invention's systems will bear an identifier, the invention destination client application will route such emails to its dedicated destination folder.

In another variation, the system can have two major categories, a category for all advertisements (i.e. local to national, opt-in or unsolicited) and another for all other non-advertisement based opted-in emails (e.g. subscriptions, bills, notices). Or, individual customized code set or identifiers and respective folders can be created based on the specific senders—businesses or the individual end user-subscriber.

Still another variation is pre-determined categories of opt-in email. For example, opt-in “news”, “subscription” or “bills” related emails could be tagged as such, then routed and sorted to their respective folders at the destination. Even sender specific foldering system can be set up. Further, a leading direct marketing list broker in USA has thousands of categories of consumer and businesses lists; also there are 30,000 commercially available lists for rent. The invention can set up unique code set/identifier of all these categories; further, these can be delivered to a general “ads” destination folder or to its category specific folder.

Some new terms to describe the invention's direct solicitation method are—“Reverse Permission™”, “Reverse Opt-in™”, and “Choice Opt-in™”. The basic “social contract” proposed by the invention for the sender of an unsolicited commercial email and the recipient is that, when and if, the recipient interacts with the invention's user interface (e.g. the folders), he/she is opting-in; otherwise they can ignore the contents. Thus the invention obtains permission, at the point of delivery—not at the point of origination (as in opt-in or permission-based email). Thus in part, it aims to overcome the issues related to the delivery of unsolicited bulk commercial emails. The invention provides a scheme to enable the “legitimate” marketers to send unsolicited notices and advertisements to their customers and prospects.

The “open delivery and direct solicitation platform” (telemarketing and the direct mail) of the traditional offline direct marketing industry (USA) has enabled it to become a ubiquitous channel for communicating to customers and prospecting. Entire industries—mail order, demographic data collections—are solely dependent on this open platform. If every telemarketing call or every direct mail had to be opted-in or permission granted, it would have greatly limited the growth of the industry; the use of its data gathering and targeting methodologies and not to mention; the pleasure of receiving and opening targeted and relevant mail. Currently, even though an individual is an offline customer of a business, unless the individual has given explicit consent (permission-based, opt-in), the business is proscribed from sending unsolicited messages or offerings. Although direct solicitations are commonplace through every major traditional communication channel—the telephone, mail and television—it is not so online. This is a big handicap for both businesses and advertisers. In part, it aims to provide “socially acceptable” means to deliver—direct solicitation, a/k/a, unsolicited—commercial bulk email—targeted or broadcasted—through a Choice Opting system where the delivery is to a dedicated destination folder that is separate from the general email inbox of the recipient and the recipient has the choice to view or not view them.

The inventor believes: that, the very intrinsic nature of the personal email inbox and current delivery channels, targetable by any party with its email address, has been the primary impetus for the current concerns over unsolicited commercial email (“spam”); that, the unsolicited or direct solicitations by businesses in USA to their customers and prospects, through the all the major traditional communication channels—e.g. mail and telephone, is well established and accepted; that, entire industries—mail order, list brokers and demographic data collectors, fulfillment centers and services—are dependent on the practices of direct solicitation; that, most consumers may accept, if not welcome, relevant and targeted offerings via email, if appropriately delivered, but just not in the very personal—current art's email inbox and unannounced.

In accordance with the teachings of the present invention, an email system is disclosed which substantially eliminates or reduces disadvantages associated with prior systems and solutions and provides new solutions and advantages never before available.

In accordance with one embodiment of the present invention, an email system using special code set, their creation, their filtering, their special handling is provided.

In accordance with one embodiment of the present invention, the code sets are tags or codes, located in the header or body of an email, special addressing methods or any distinguishing and special pre-determined distinguishing method.

In accordance with one embodiment of the present invention, the code set can serve or instruct more than one specific action. There can be multiple levels of code set. For example, the fact that the code set identifier is attached serves to distinguish it from non-identifier carrying email, and then it can instruct the specific destination interface or Folder to be routed to, further to a sub-category or more specific category within a category. If a Folder for such email does not exist at the destination, then the email can be delivered to the next higher-up level category Folder. For example, an email carrying an code set as “Supermarket” category can be placed in the “Local Ads” Folder, if a Supermarket Folder does not exist, further, if the “Local Ads” Folder does not exist, then the a default main Folder of the invention.

In accordance with one embodiment of the present invention, the invention destination foldering system can be separate from the default email client of the subscriber; or it can be integrated with it, further for some it may be the default local email client—where it will create at least one other folder for all emails not bearing code set and using its standards.

According to a further embodiment of the present invention, the advertiser desires to have their email delivered through the invention's Deliverable Network, then by entering their identity and after verification process, and after choosing the desired category(s), the special code set or identifier(s) will be provided to the sender. The sender then can attach such code set to their emails.

In accordance with one embodiment of the present invention, by filtering the unique code set that instruct the subject or the sender's identity, the ISPs may have further options to determine the types of emails delivered to their subscribers. Advertisement offerings from competing ISPs can be excluded. Putting certain subjects or senders on “non-approved list” with their respective code set, respective to each ISP, can do this. Or all commercial email deliveries can be first routed to the ISPs for review before allowing for distribution to their respective subscribers' folders. For example, an ISP may exclude advertisements from competing ISPs. It can be accomplished at server level, or local filtering level.

In accordance with one embodiment of the present invention, the emails using the invention's standards and code sets are delivered to their designated category interface or folder.

In accordance with one embodiment of the present invention, if using a multiple folder and category system, each of these folders is based on certain pre-determined and subject categories. For example, a “Bills” folder can receive emails related to bills and invoices, a “Subscriptions” folder can received emails related to news and subscribed information services—these are generally deemed to have been opted-in or permission based. Or there can be a single master folder that in it will contain tabs or links to other folders. Or if to be delivered to the current art defaulting email folder then optionally to be caused to be specially highlighted with visual markings to indicate its specially sent nature and category of the email.

In accordance with one embodiment of the present invention, each demographic category can be assigned its own code set and for folders, e.g. an “airplane pilot” or even a subcategory—“single engine airplane pilot”.

In one embodiment of the invention, the main subscriber is the representative of the household for targeting purposes. One reason being, the main subscriber name and address are assumed to be known to the ISP from the billing address for the services purchased by subscriber from the ISP. If the main subscriber wishes to share a particular folder with other members of the household, forwarding or “cc” can be done. For example if the husband is the main subscriber, then he may choose to forward all emails under the category of “MyAds” to his wife's folder. The invention systems will provide such user functions. Such emails can have its own code set and be delivered to its own destination folder.

“Yahoo! also maintained that compliance with the court's judgment would be a technical impossibility due to limitations in filtering technologies and difficulties in identifying which users originate from France. But a panel of experts, which including . . . , an early architect of the Internet, concluded that a high percentage of French users could in fact be successfully blocked, especially those connected through French Internet service providers. Software manufacturers, like U.S.-based Quova, agree. (He) has stated that his technology would allow Yahoo! to locate a user's origins with approximately 90% accuracy.” News release.

Summary of Online Target and Direct E-Mailing/Maketing

The invention's database mapping system and methods relates to using a names and addresses list and one or more subscriber/customer list/database of the email and Internet service providers. The subscriber/customer list/database of the email and Internet service providers will have the billing address and the email address or some other targetable IP address of their subscriber/customers. It will use such to effectuate the delivery of targeted emails to the matched names and addresses in both lists.

Some of the problems solved by the invention include system and method for enabling a third party names and addresses (i.e. postal addresses) to be matched or mapped to the subscriber databases of the email and Internet service providers in order to cause the extracting, the mapping or the appending of email addresses to the third party names and addresses list. To date, the inventor believes that these subscriber databases have not been made available for mapping to third party names and addresses list—because even if an email addresses was provided to a marketer, they were proscribed by current “recommended” email marketing practices from sending un-solicited communications. Further, the invention provides for system and method that enable the email and the Invention service provider to completely keep secure the subscriber data, such as the matched names and addresses and/or the email addresses, yet allow the email to reach the subscribers of the matched names and addresses, this is accomplished by various means. The current art's means for acquiring or appending email addresses have been through primarily a manual process of acquiring one-by-one—for opt-in or permission based, or using robots or such programs for gleaning email addresses. The invention provides for systematic and automated methods for use of email addresses database of the subscribers of the Email and Internet service providers.

The invention's methods, for the mapping the delivery of advertisement or marketing material to the destination subscriber includes, mapping to the subscriber database of ISPs to append email addresses; the IP addresses of the intended subscriber's devices; such as the unique IP of the interactive, Internet or email enabled TV. For interactive TV, the latest generations uses a set-top-box to convert the signals, to monitor usage, to store data. It also has a unique address. As with other subscriber information such as their email address, this IP address can be used to identify the household for targeting purposes. The interactive TV Cable Network providers know the IP addresses.

The invention's mapping methods enable senders, to map desired names and addresses list to the subscriber databases of the Email and Internet service providers and thus effectuate the delivery of their advertisement to the said names and addresses. The email communications can be further tagged with the invention's code set and routed to their respective destination email folders at the recipients. For example, if the communication is direct solicitation advertisement, then to a designated “Ads folder”.

In accordance with the teachings of the present invention, methods of using demographic direct marketing/mail lists and subscriber data of Email and Internet service providers is disclosed which substantially eliminates or reduces disadvantages associated with prior systems and solutions and provides new solutions never before available.

In accordance with one embodiment of the present invention, an online interface or computer is provided for accessing server/database. Such “Broker” sever/database contains, or is networked to access, one or more demographic databases and one or more subscriber databases. Optionally, the demographic databases and the subscriber databases can be housed separately. Typically an advertiser will conduct a search at the Broker's system or will already have a names and addresses list. If they wish to conduct a demographic search at the Broker's demographic servers, then they can select from the various categories and obtain names and addresses. Once the names and addresses are obtained, then the process for mapping to the subscriber email addresses can be started. Such names and addresses list is sent to one or more of the selected Email and Internet service providers' servers housing the invention's matching and mapping program. The matched results are outputted such information provided to the advertiser.

In accordance with one embodiment of the present invention, opt-in email or permission based lists are “reverse” mapped one or more demographic database to yield greater demographic profile, and the names and addresses associated with the email addresses, by mapping the email addresses to a subscriber database and obtaining the names and addresses, the mapping the names and addresses to the demographic databases, some email addresses may not be identifiable as they are not part of the invention's email and ISP subscriber databases. Other email addresses may be identifiable to postal addresses but not to a name—e.g., AOL™ allows several additional email addresses per Subscriber's account most which may be used by other non-named household members.

In accordance with one embodiment of the present invention, a free (non-paying or non-subscription based) email service can acquire the names and addresses of its users and thus build a subscriber database that can be mapped with demographic database. Instead of asking for voluntary, name and address, information from their users and where such data can be deemed to be “subjective”, they can ask their users to provide credit card information. Such credit card information is use to verify (“objectively”) a name and postal address of the user. Such information is verified with the credit card industry's verification procedures. For example, the free email service providers—Hotmail™ or Yahoo!™ could ask for the credit card of their users for name and address verification only and perhaps in return offer additional services not available to the non-providers of credit card information.

According to a further embodiment of the present invention, the subscribers can select such folders/category from a demographic directory and thus cause they to be associated/listed with such demographic category. Such association can be merged to the existing demographic database or as the subject demographic category may have originated from third party data sources, such new additions to the demographic databases can be kept separately but still accessible to all searches of the subject demographic category. The subscriber can select and list themselves, on say, “Golf”, “Fishing” and get offerings from senders who are sending emails under those subject areas. Certain additional demographic information on the subscriber can be added to that data to help the marketer further define the subscriber. Folders can have sub-folders. That is all dependent on the invention's local client's capabilities. The subscriber's listing data will be added to the system's demographic database under the selected categories and made available for searching by Advertises. However, since much of the demographic data in the invention's systems are presumed to be provided by third party demographic data providers, such new listings (generated by the invention's system) should be kept separately from the thirty party demographic data (or perhaps credited to the subscriber's ISP). For example under a “Golf” category the information on the subscribers' that voluntarily listed themselves are held in separate fields from the third party's data.

The invention also provides method and system for an anonymous email sending where the user desires to compose or respond to a solicitation email, but without revealing their email address. Anonymous reply/request is part of the email client interface. User selects the anonymous reply/request feature and sends out email. The system will check the email and replace the user email address with an automatically generated, one-time-use-only email address. The advertiser who receives this message can still reply to this message and the system will check the message and replace the user's email address and delivers it to the user. However, the email address will be disabled after that single delivery and nobody can send message to it again.

Summary of Email Banner™

A “graphical, banner style display” for email (“Email Banner™”). It means to provide the typical email address header information (the “From”, “To”, “Subject”, etc) in a rich visual and/or interactive-graphical banner display “in lieu” of the current “text” only email headers. It can be visually similar, to the online advertisement banners, and of varying sizes. There will be an application at the destination client interface to compose and display such and the attached advertisement or marketing material, if such destination application are not installed, then the normal or current art email “text header” will be used.

Some of the problems solved by the invention are that the current email text headers cannot convey rich graphical images (video, colors, pictures, etc) and are confined to limited horizontal space. Just as in the postal mail, the envelopes for advertisements come in a great variety of design, color, shapes and sizes; the invention provides a comparable value for the emails.

In accordance with the teachings of the present invention, an email inbox and email displaying and system is disclosed which substantially eliminates or reduces disadvantages associated with prior systems and solutions and provides new solutions never before available.

According to one embodiment of the present invention, a graphical banner like display is used in lieu of the current arts inbox for text based header for email. It is transported over the typical email protocols and displayed at the destination client. It can be created at an online web interface where templates of appropriate sizes and styles are provided to the user. User can stylize the header in a variety of ways. If desired, the sender name, the names of the intended recipients are automatically populated into each header. Where a recipient name is not available, “Resident” can be inserted. Hyperlinks or other resources are attached to the header, including a typical email body. The recipient's destination application recognizes the header bearing email and displays such. If a destination application does not recognize the header bearing email, then default email client will handle it.

According to one embodiment of the present invention, the graphical-banners in a single campaign can be customized based on known demographics of the intended recipients. For example, if the Subscriber is deemed to be “male” then a blue background can be automatically filled into the background of the Email Banner™, if “female”, then a pink background. This can extend to fonts styles and images. If the preferred second language of the Subscriber is a known demographic value, then translation can be provided, whereas, other Subscriber will receive the same in dominant language.

Summary of the Electronic Mail Banner™.

The current art's email header systems uses a text based system to provide their header information to the viewer. This can be seen to be comparable to forcing all postal mail to use a same-uniform look and sized envelope; for one, marketers would have difficult in differentiating their mails. The invention provides for a “rich graphical-banner style header” for emails as opposed to the current arts—linier, text, based headers. This graphics display can be described as to be similar in look and feel to the online banner ads and analogous to the offline direct marketing envelope. It can generally contain the sender's info, the subject and the recipient's name, the subject of the email. The Email Banner™ are delivered to its dedicated destination “folder” or interface receiving such. Each Email Banner™ can be linked to the main advertisement body or other online resources. The user destination interfaces have similar functions as a typical email client so that the subscriber can delete, save, and reply. The Email Banner™ can be of different sizes and shapes—e.g. small, medium and large—and a commercial sender can be charged accordingly.

In the traditional direct marketing industry, the creation and use of the advertisement envelope or the exterior mailer package, is considered to be a separate and important art in itself—to get the recipients' attention and compel them to take action and open the envelope. Under current email text-header based system, the direct marketers are not able to distinguish their “envelope” (i.e. email header) from any other email. The graphical rendering of the emails headers for commercial advertisement offerings will be visually more appealing to the recipients, convey richer information and further distance in the recipient's mind from the text-header based “spam”. The importance of graphical banner to attract attention and to compel action is the enormous variety of styles and techniques used by the current web page banner advertisements.

The Email Banners can have varying sizes, shapes and properties—for example, when the mouse cursor moves over the Email Banner, some interactive message can be activated, such as binary files e.g. sound, pictures and video can be attached and activated, even “Instant Message” function linked to the Sender's sales department, etc. Each can be linked bring up the main body or additional resources of the advertisements. The Email Banner system can be made so that if the recipient does not have an application able to display the Email Banner™ headers, then traditional header style will dominate. The body of the advertisement is same as current arts. In one example, a graphical-banner header email will contain an identifier indicating is as such, and routed to the destination application able to convert and display such headers. If, not recognized, then the email is handled and shown as normal.

The interface or the “inbox” for the Email Banner™ can be similar to the browser or pop-up windows. These Email Banners™ can be laid out in vertically and horizontally. The contents of the inbox can be updated periodically by the system. For example, the Email Banners™ and the advertisement body for expired and unread offers can be deleted. Further, the Email Banner™ can be sorted in a variety of manner; a default sort can be based on the “arrival” or the “postmarked” dates of the mailings.

Information such as the “From” field for the Sender's name or logo, a “Subject” area, and “To” area. The “To” can be filed with the intended subscriber's name “Mr. John Q. Smith” or even a simple “Resident”. Once the sender has chosen a style for the respective fields in an Email Banner™, the data for the fields can be converted from the demographic or subscriber database fields.

It is an objective of the invention to provide methods and systems for rich graphics-banner style based header for emails, its transport, handling and display.

It is an objective of the invention to provide methods and systems for creation of such, including online templates, or appending of such by an advertiser to their existing advertisement creative

It is an objective of the invention to provide methods and system for automatically populating the appropriate fields in the graphics-banner style email header such as the “From”, “To”, “Subject” fields.

Above and other objectives are disclosed in this document. These and other objects of the invention will be apparent to those skilled in the art from the following detailed description of the invention, the accompanying drawings and the appended claims.

### SUMMARY OF THE INVENTION

What the present invention accomplishes—in its various parts, collectively and/or independently—which no previous system has done before:

is to provide a email system that has all the comparable functions as the present art email systems and can be provided to be an add-on to or to replace the main local email client, where its delivery system is only usable to senders and their emails that uses the system operator's proprietary usage standards, protocols and code set for the routing and delivery of their email, and where non-approved sender or non-identified emails are blocked from delivery even though they have the email addresses, while the current arts use the recipient's email addresses as the routing and targeting method, the invention uses one or more additional layer(s) of distinguishing means that represent “approved” sender/email, the subject or category of the email and their designated destination folders at the intended recipient's destination client, it can be seen as a self-contained, but public, email system—that uses the current art email systems, transport protocols and distribution—but is a private and proprietary system, thus it has right to control the users of its systems;

further the invention's provides for the first automated mapping and appending of email addresses contained in the subscriber and customer databases of the email and Internet services to a third party names and addresses list, where the user can go directly to such databases at the email and Internet service providers or a broker systems that is in turn liked to the various subscriber databases, further, where the system provides for a blind searching and matching so that the email addresses to not have to revealed to any third party (including the intermediary broker), also the subscriber and customer list of Email and Internet service providers can be reversed mapped to one or more demographic databases to yield demographic data on their subscribers and customers,

further, the invention provides for a rich graphical-banner style email header and display interface to be used in lieu of the current art text based header and inbox interface, templates for its creation, transport, its identifying and displaying at the local destination client.

Term Description

Code set—In the context of this application, it means one or more rules or codes that have been prearranged among the email senders and receivers, which are instructions for the receiving email server or program to take “certain actions” or treatment for the email, including delivering them to their designated destination folders—based on any possible category, such as bills, subscriptions, advertisements, sender specific, destination group specific, high priority; forwarding—actually the “certain actions” can be any action that have been prearranged or pre-determined among senders and receivers.

Subscriber(s)—The customer of email and Internet access service providers, where the customer has provided a postal address for the purpose of billing for the payment of the services. Also, for free email or Internet access services, where such services have requested a credit card or similar for the purpose of verifying the user's identity and address. Also is referred to as the “master” or “main” subscriber, to differentiate from other users of the subscriber's account—for example, an Internet access subscriber of AOL.com is allowed to have multiple email addresses, the main subscriber is the party associated with the billing address.

Deliverable Network—The network of the email and the Internet service providers that use the invention's special code set, standard and handling protocols and/or providing access to their subscriber database to allow mapping of a names and addresses list to their subscribers.

Email and Internet service providers (or also just ISP)—These are the online services that provide email or Internet services. Examples of email service providers are web email services such as Hotmail, Yahoo!, example of Internet connectivity services is AOL, Earthlink, etc.

Demographic (Values, Profile, Data)—This is used as a general term. Generally, the major components are: the psychographic—generally the psychological makeup of the target audience; geographic—the location of the target (e.g. state, “Section Center Facility”, zip code, county and metropolitan area; demographic—quantitative characteristics of a given population by age, income level, wealth, gender and other vital statistics of personal nature. Business to business lists often offer selections by industry, job function, number of employees, and products bought or specified. Source—www.edithromam.com (a top 5 direct marketing list broker in USA).

Electronic mail, email—This term is intended to broadly encompass the email message and any attachments thereto, including, without limitation, text, documents, files, graphical objects, data objects, multimedia content, audio/sound files, video files, MPEG files, PEG files, GIF files, PNG files, HTML and XML documents, applications, formatted documents (e.g., word processor and/or spreadsheet documents or files), MP3 files, animations, photographs, and any other document, file, digital, or multi-media content that can be transmitted over a communications network such as the Internet.

Regarding the Email and Internet service providers—The invention will tailor its applications to the proprietary systems of ISPs and email service providers in its Deliverable Network There are at different types of service providers (“ISP”). ISP includes the email and Internet access services through—PC, email and Internet enabled interactive TV, the email, SMS, and Internet enabled wireless personal communication devices. These ISPs vary in their services and types of subscriber databases, the recommended default email systems and email clients. For example:

The ISPs that provide their own proprietary email clients—local or web (e.g. AOL™, plus have the postal (i.e. billing) names and addresses of their subscribers. Although, they are able to target geographically due to the known postal addresses, they lack the “traditional” direct marketing demographic data (although they may have other data collected via—cookies, tracking, click streams, etc).

Another is the free ISPs (e.g. Netzero™, Yahoo!™, Hotmail™), they have some demographic information volunteered by the users, but as these are voluntary, they can be incorrect or is “subjective”. So in general, they control the email client (locally or the web) but do not have the “traditional” demographic information and also do not have the “objective” postal (i.e. billing) addresses of their users. However, they can ask for credit card information from their free subscribers to use for address “appending” only, which is then mapped to the invention's database mapping system.

The ISP that provides Internet access but does not provide the web email service or local email clients. Their Subscribers' typically use the third party software, e.g. Outlook™, Eudora™. But these ISPs have their subscriber postal (billing) address (but lack again the demographic info). Examples are, Time Warner Road Runner cable Internet service—to note, Time Warner Road Runner (cable) does not install their application on their Subscriber's local computer. Earthlink™ DSL does not provide local email client, but provide web email service. A plug-in to the local email client can be provided. It is also possible to install the local application and system in the local modem (the set-top box if an interactive TV) provided to the subscriber by these SPs.

Another is the email client application provider (Outlook™, Eudora™), they only provide the local email application and do not have the subscriber postal info, and of course the demographics info, and not the access to the Internet. But these are important because some ISP providers effectively assume their usage by their Subscribers as the preferred local email client. Our application and it user interfaces can be “plugged” into a “default” email client at the time of the installation of their software or by a separate installation.

Another is local email client application provider and web service provider. MSN Hotmail and MSN Explorer. Microsof™ controls the Outlook™ and also provides Internet services through their ISP services. MSN Hotmail has been recently integrated with the Outlook 2002. Outlook 2002 includes full Hotmail support, but with some limitations. Outlook 2002 also supports HTTP access to MSN accounts and mailboxes on Exchange 2000, but not to other HTTP mail servers. Thus if the Hotmail is using the invention's code set identifier system, it is possible that such emails are routed through to the Outlook. There the user can organize their folders to route the code set bearing emails to Outlook folders.

Also, Microsoft Passport's NET Passport (or similar online wallets), stores is members' information in a wallet that provides one sign-in name and password at all NET Passport sites. It does not provide any Internet access or email services but such services have the names and address and an email address of their users. The names and addresses and/or the email addresses of their members can be reverse mapped to databases to acquire or append demographic profiles to the individual's data in such wallets. This additional information can be used by the NET Passport sites to send targeted advertisements to the email addresses.

Thus, while one ISP may control both the subscriber database, and the local and web email clients, another ISP may only have the subscriber database. The invention's various code set and routing systems, its applications, its database mapping, its destination interfaces on the subscriber's computer, etc. can take on a variety of embodiments to adapt to each ISP's system and preferences. For example, one ISP may allow only a single destination folder for all advertisements related emails—opted in or not, regardless of the categories, then all of the invention's advertisement emails will be routed to that folder; another may allow multiple advertisement folders.

While the invention has been particularly shown and described with references to its various embodiments thereof, it will be understood by those skilled in the art that various changes in form and details may be made without departing from the spirits and scopes of the invention.

### BRIEF DESCRIPTION OF THE DRAWINGS

FIG. 1 is diagram of the invention's electronic email code set method and system.

FIG. 2 is diagrams of the ISP database mapping method and system.

FIG. 3 is diagram of Email Banner method and system.

FIG. 4 is a main destination folder on an ISP proprietary email client.

FIG. 5 is destination folders on an ISP proprietary email client.

FIG. 6 is a destination folder/interface scheme on a post log-on portal page of an ISP.

FIG. 7 is destination folders on a web-email client.

FIG. 8 is destination folders on a local email client.

FIG. 9 is further embodiments of an email client.

FIG. 10 is further embodiments of destination category folders and an Email Banner™ scheme.

FIG. 11 is further embodiments of destination category folders and highlighting.

FIG. 12 is the main destination folder on email or Internet enabled interactive TV.

FIG. 13 is an embodiment of an advertisement category listings display on the interactive TV.

FIG. 14 is the Email Banner's main display.

FIG. 15 is alternate ways for an opened email from Email Banner.

FIG. 16 is a reverse database mapped “card” for a subject subscriber.

### DETAILED DESCRIPTION OF THE DRAWINGS AND EMBODIMENTS

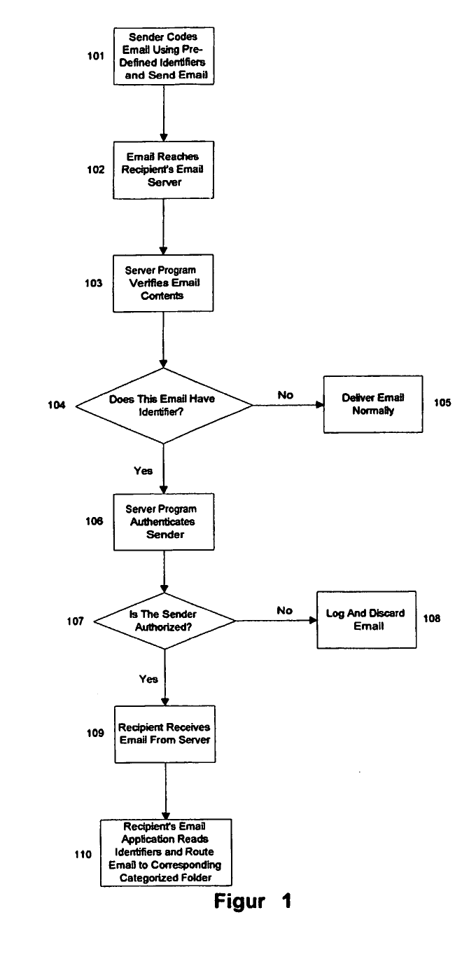

FIG. 1

At 101. Sender is advertiser or broker. Coding email means composing any part of the email including email header, body, and/or attachment using predefined code set or identifiers. One embodiment of predefined code set or identifiers is using XML. One example is as following:

<MYSORTS rev=1.021>

<ADS>

<INDUSTRY type=“SUPERMARKET”>

<DIGITALSIG>lsadhv93418foiq3j8f31j0ru10329ur02138jf931u4-

321j9dp084n10o8rj03148jr31</DIGITALSIG>

<COMPANY>Waldbaums</COMPANY>
<MSG>10% off at all waldbaums store tonight only</MSG>
<DISCVALUE>10%</DISCVALUE>
<DISTZ1P>11510</DISTZIP>
<IMG>http://www.walbaums.com/logo.gif</IMG>
<URL>http://www.walbaums.com/</URL>

</INDUSTRY>
<LIFESPAN>

<STARTDATE> 11/01/01</STARTDATE>
<ENDDATE> 11/30/01</ENDDATE>

</LIFESPAN>

</ADS>

</MYSORTS>

This example shows a section of code that uses MYSORTS revision 1.021. It's an advertisement sent by “Waldbaums”. It has a lifespan, which means it will be removed automatically from recipients mail system when it expires.

At 102. Email is routed to recipient's email server.

At 103. An application on recipient's email server checks the mail for pre-defined identifiers. In the previous example, the application will check for identifier pair <MYSORTS> and </MYSORTS>.

At 105. If the email has no predefined identifiers, the email will be delivered normally.

At 106. If the email has predefined identifiers, the email will be checked for authentication information. The authentication part in the previous example is using company name and digital signature. The sender signs the email using their private key, the recipient server can verify the sender information the email using sender's public key. The sender can also encrypted the email using their public key, and then the receiver can decrypt the email using sender private key.

At 108. If the sender failed authentication, the event will be logged and email message will be discarded.

At 109. If the sender is authenticated, the email message will be delivered to recipient's mailbox and will be accessible to recipient's email application.

At 110. Recipient's email application reads the incoming tagged email message and stores it to a corresponding categorized folder. The “email application” includes Web-based email application, local email application, and other Web or Email-enabled devices.

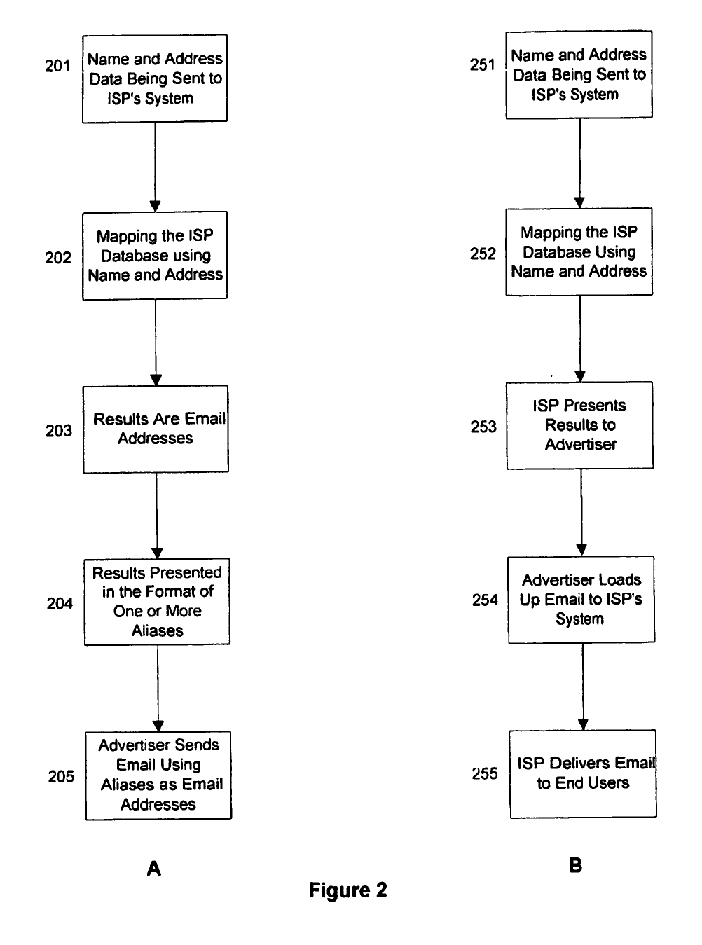

FIG. 2

Embodiment A

At 201. Sender, includes advertiser and broker, sends Name and Address data to one or more ISP's systems in order to search for matching email addresses.

At 202. An application on ISP's server retrieves Name and Address data and search ISP's database to match records.

At 203. The matching results are email addresses.

At 204. The ISP's system notices the sender the number of the matching email addresses.

The sender can decide to use all or part of the results. The ISP's server will not send real email addresses to the sender, instead, one or more aliases will be created representing the matching email addresses and be available to senders.

At 205. Sender uses aliases as recipient email addresses.

Embodiment B At 251. Sender sends Name and Address data to one or more ISP's systems in order to search for matching email addresses.

At 252. An application on ISP's server retrieves each Name and Address set and search ISP's database for matching records.

At 253. ISP presents the sender the number of the matching records. The sender can decide to take all or part of the matching email addresses. The selected email addresses will be the recipients.

At 254. Sender loads up email to ISP's system.

At 255. ISP delivers email to recipients.

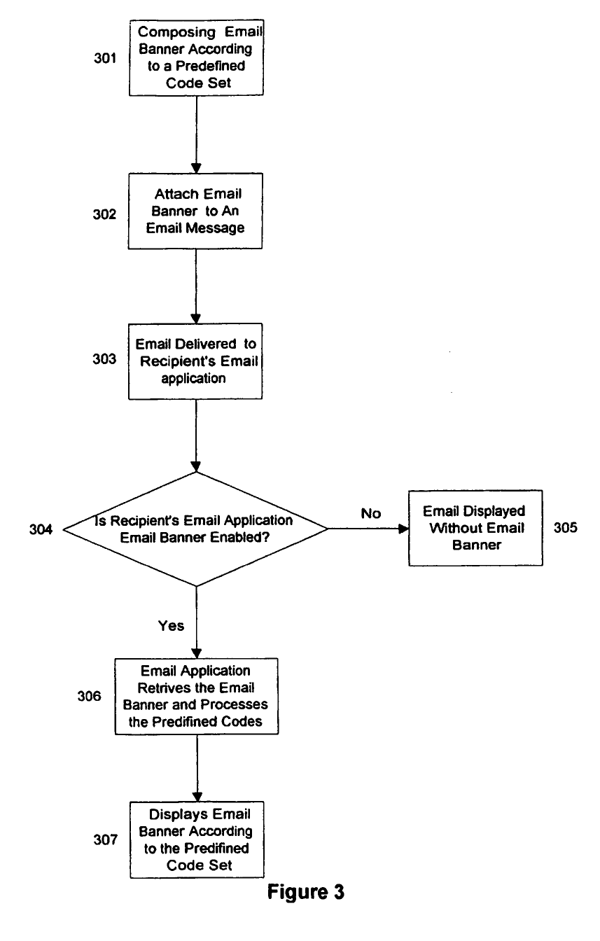

FIG. 3

At 302. Email Banner can be attached to an email message as attachment. Or it can be a part of the email body.

At 303. Recipient's email application includes local email application, web-based email application, or any Web or email-enabled devices.

At 304. If recipient's email application is not Email Banner enabled, the email will be displayed as normal email messages, without Email Banner.

At 306. If recipient's email application is Email Banner enabled, the email application will read the Email Banner portion and process the codes in the Email Banner.

At 307. Recipient's email application displays the processed Email Banner portion as a graphical banner when recipient requests to view a list of emails that contains Email Banners.

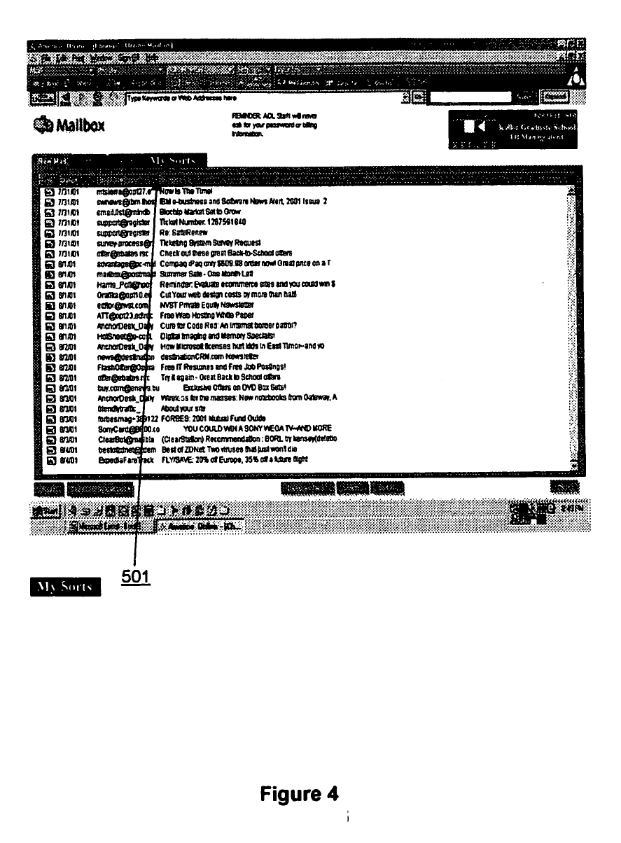

FIG. 4

FIG. 4, per methods and systems of FIG. 1, is embodiment of a destination email client with “tab” 501 that is a main tab for the accessing a main menu where one or more destination category folders are available. Also the system creates new folders in the main menu on behalf of the user/subscriber.

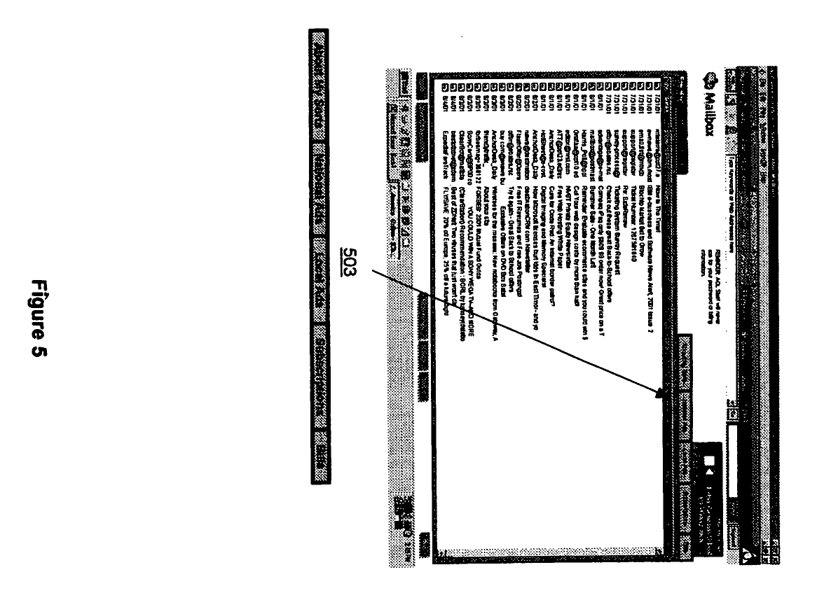

FIG. 5

FIG. 5, per methods and systems of FIG. 1, is embodiment of a destination email client with “tabs” 503 that are the destination category folders. Each folder will list and display emails bearing it's code set.

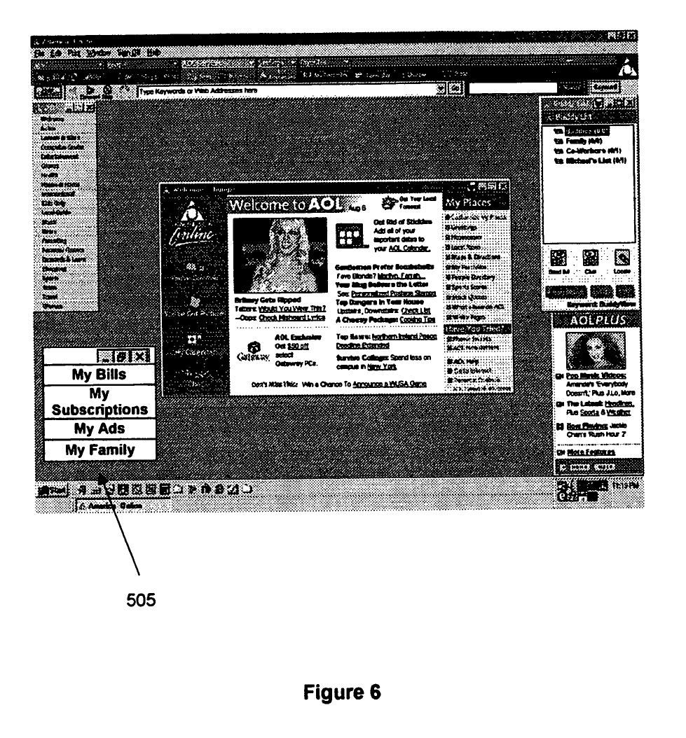

FIG. 6

FIG. 6, per methods and systems of FIG. 1, is another embodiment of the destination email folders or interface 505 at a home or portal page of the subscriber. A “My Family” folder has been designated by the subscriber to retrieve emails related to certain demographic categories that the subscriber had previously selected and instructed to route to this folder.

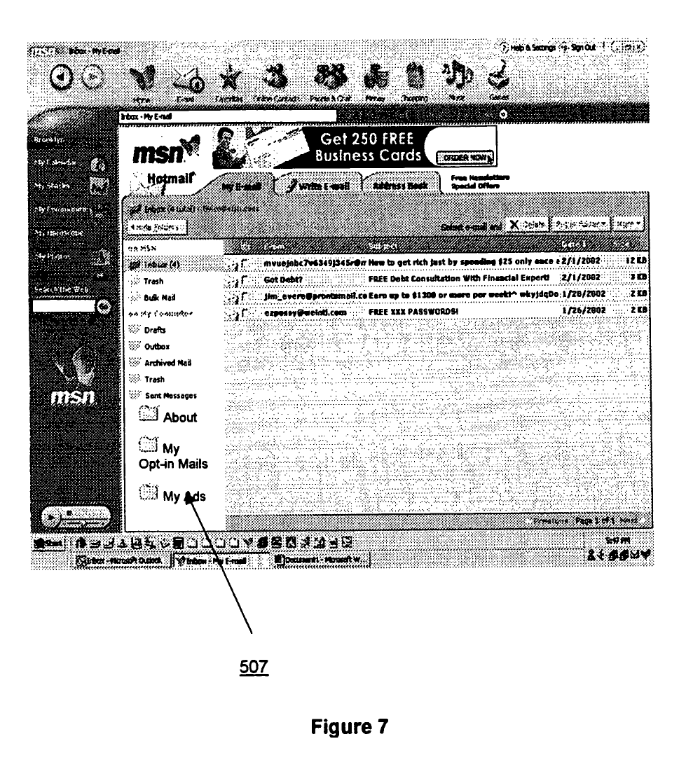

FIG. 7

FIG. 7, per methods and systems of FIG. 1, is an embodiment of the destination email folders or interface 507 on a web email client. This embodiment shows three folders—“About”, “My Opt-in Mails” and “My Ads”. A web email service provider can further forward emails to local client folders.

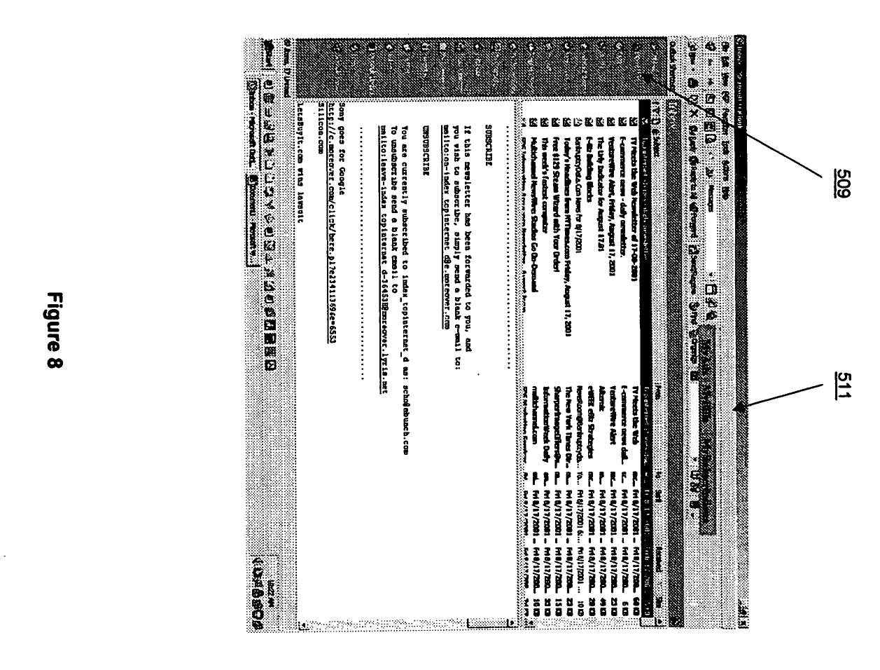

FIG. 8

FIG. 8, per methods and systems of FIG. 1, is an embodiment of the destination email folders interfaces 509 and 511 on a local email client (e.g. Microsoft Outlook™). This local client can receive forwarded emails from a web email client as described in FIG. 7.

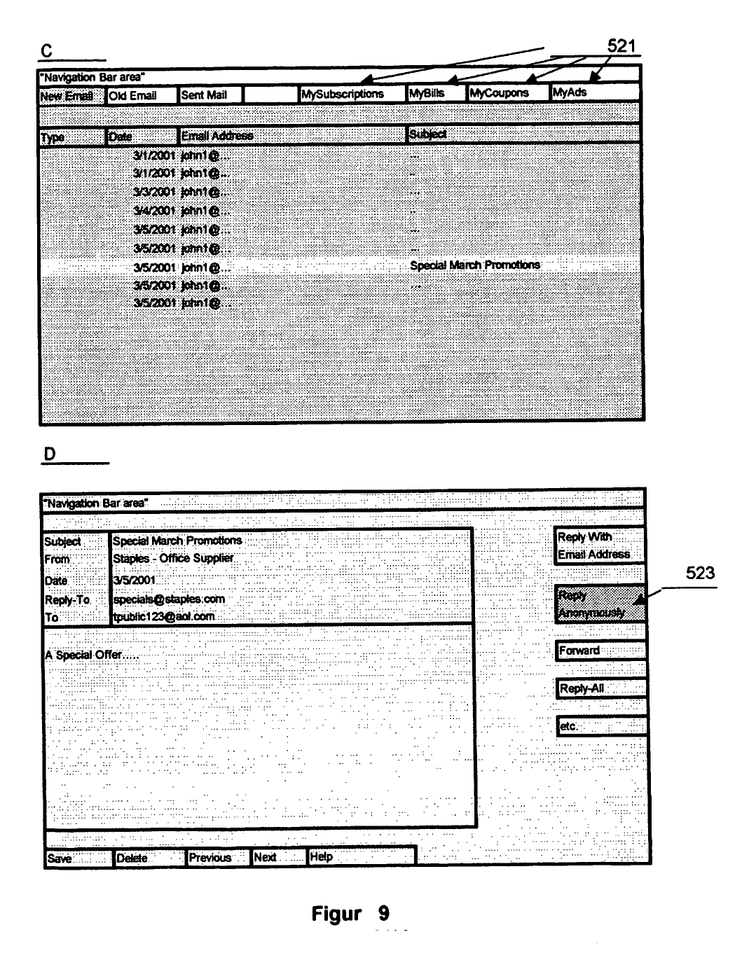

FIG. 9

FIG. 9, per methods and systems of FIG. 1 is an embodiment of a “current art” email client C of an ISP—e.g. “AOL.com” with the invention's folder tabs 521. Selecting a tab will open that folder. FIG. 9, D, is an embodiment of the invention anonymous replier function 523. Activating 523 will open an anonymous reply email writer.

Anonymous reply is part of the email client interface. Invention or the destination email client service provider can handle it. Email recipient/user selects the anonymous reply/request feature and sends out email. Invention system will check the email and replace the recipient/user email address with an automatically generated, one-time-use-only email address. The advertiser who receives this message can still reply to this message and invention system will check the message and replace the recipient's email address and delivers it to the user. However, the email address will be disabled after that single delivery and nobody can send message to it again. An example of how one-time-use-only email address is generated:

The system keeps a list L1 of all the email addresses that has been used;

The system maintains a table T1 of all the one-time-only email addresses and their respective real email addresses;

An algorithm randomly generates an email address, A1;

System searches the list L1 to see if there is a match to A1;

If yes, go back to step c;

If no, the address A1 will be used as the one-time-use-only email address and email is forwarded;

System will update table T1 with the A1 and its counter-part real email address;

Upon reply to the A1, the system will match to T1 and forward to user.

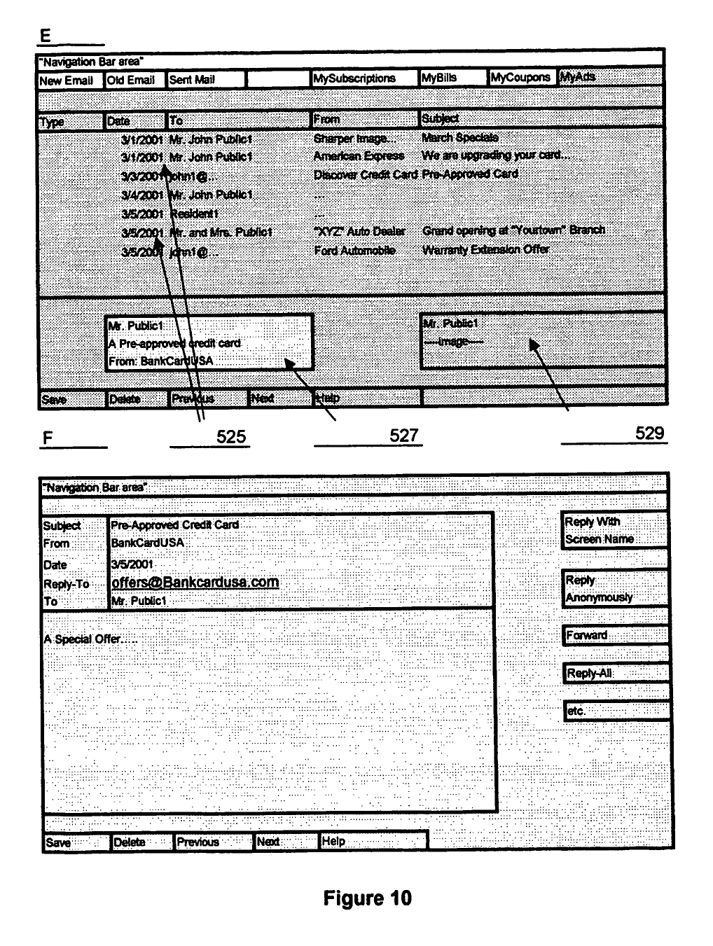

FIG. 10

FIG. 10, shows an embodiment E with category folder “MyAds” opened. This is an embolden of where the folder is using both the current art “text header” email listings 525 and the invention's Email Banner™ 527 and 529 listings. F is one embodiment of the displaying of the email upon selection 527; alternatively a separate pop-up browser window containing the advertisement message can be displayed or even to any other web page of the advertiser.

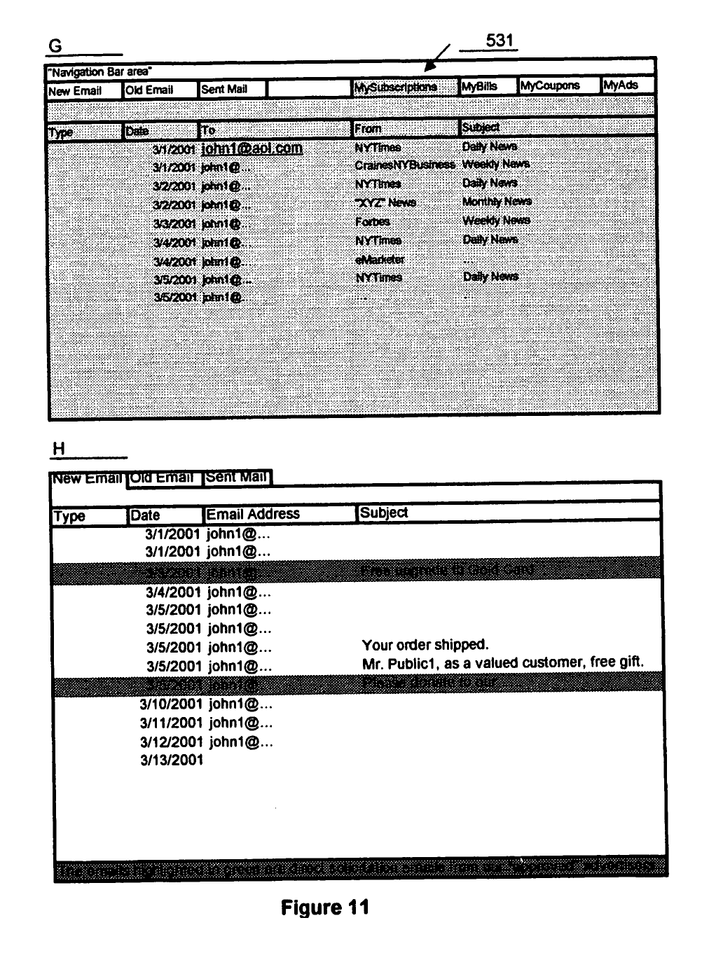

FIG. 11

FIG. 11, G, shows the designated destination subscriptions folder 531 opened with its designated emails.

FIG. 11, H is an embodiment of the invention where certain emails are “highlighted” within a folder.

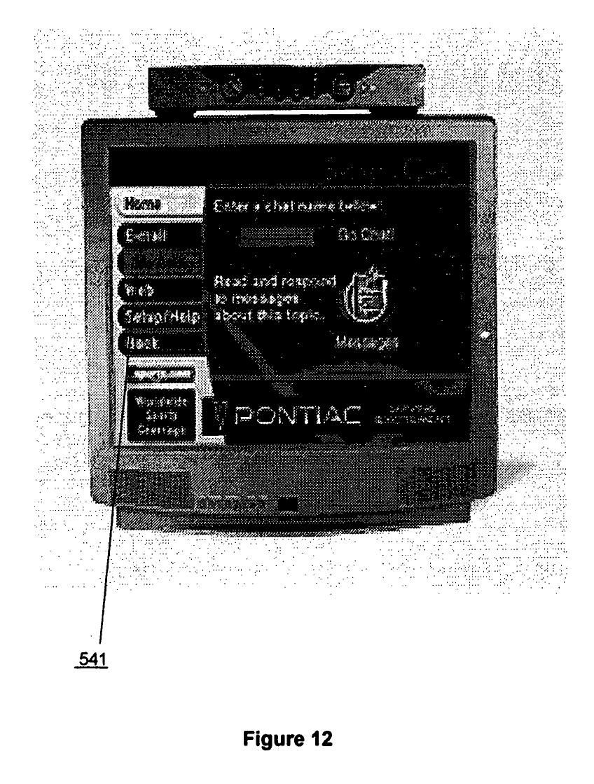

FIG. 12

FIG. 12 is an embodiment of the invention's main destination folder 541 on an electronic interactive TV guide/user interface for email and/or Internet enabled interactive or digital TV (satellite or cable). The 541 are accessed by keys on the TV remote control or keyboard, and will open one for more destination folders. The invention's enabling program can be loaded and stored at the set-top box for the interactive TV or located at a head-end of the interactive TV service provider (aka Cable Network Operator).

Some of operating application providers for the set top box of the interactive TV systems include: Worldgate (wgate.com)—“Using Channel HyperLinking, cable subscribers throughout the world already are reaping the benefits of the new interactive paradigm for TV. The technology allows viewers to link—at the touch of one button—from a TV program or ad to directly related Web-based interactive content. Channel HyperLinking connects TV viewers to a wealth of information on a topic, product or service as well as online shopping and interactive programming opportunities, such as the ability to play along with a game show or respond to a survey. To return instantly to the program they were watching, viewers need only touch a button on their wireless keyboard or remote control.” “Subscribers to WorldGate's Interactive Service can enjoy the entertainment and information value of e-mail, games, chat, calendars, localized content, t-commerce, interactive programming and advertising, Web access and more.” www.wgate.com.

Another is Liberate—“Liberate Technologies Overview: Liberate Technologies is the leading provider of open platforms for delivering enhanced content and services to television viewers around the world. Major cable and satellite television operators, telecommunications companies, and Internet service providers use the Liberate software platform to increase consumer satisfaction and create new revenue streams by offering a revolutionary two-way experience on the TV set. These interactive digital services include enhanced TV broadcasts, electronic program guides, video-on-demand, personalized content (including local news, weather and other information), TV chat, instant messaging, digital video recording, and much more.” http://corporate.liberate.com/

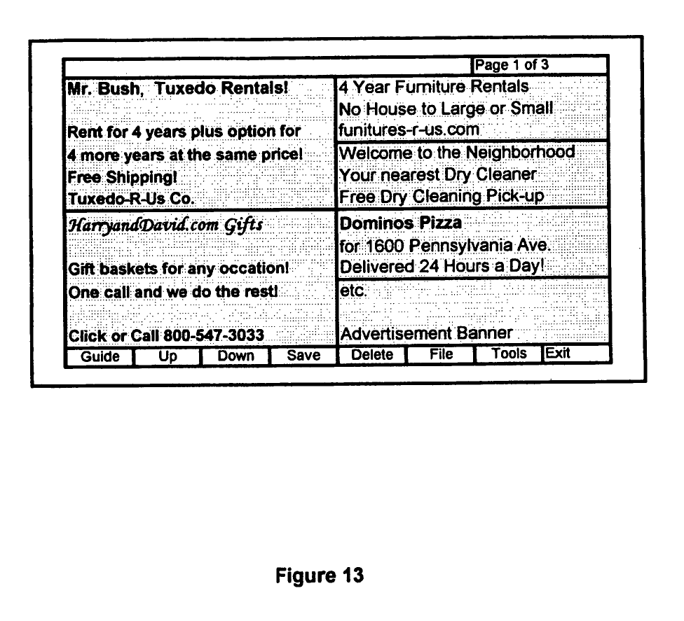

FIG. 13

Upon activation of the 541 in FIG. 12, various targeted advertisements are shown to the subscriber of the iTV service on the screen of the iTV. Each advertisement is selected by the remote control or keyboard. The “banner” portion of advertisements can be stored locally in the temporary memory of the set-top box and the main body downstreamed from the head-end servers upon selection of an advertisement by the subscriber/user.

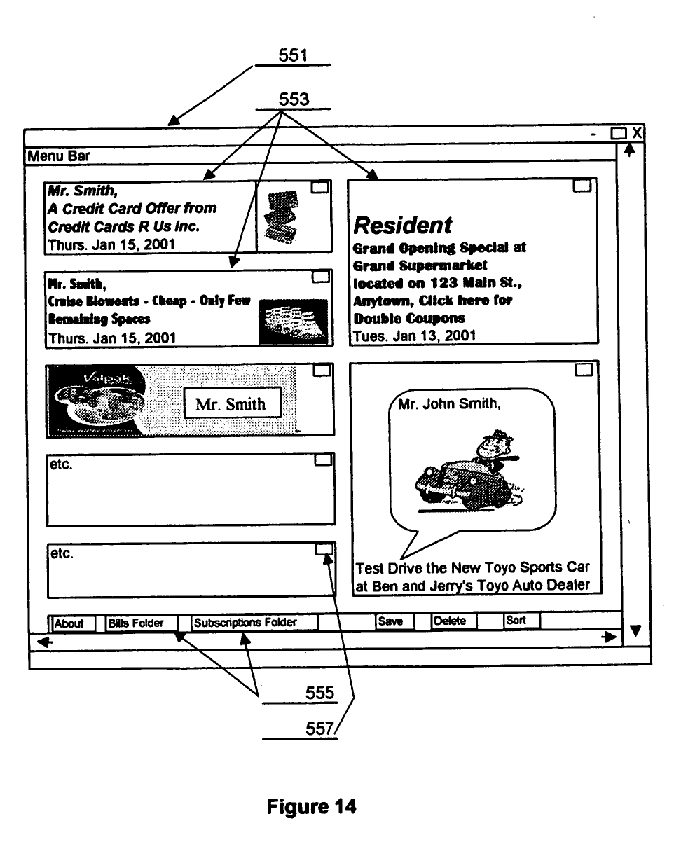

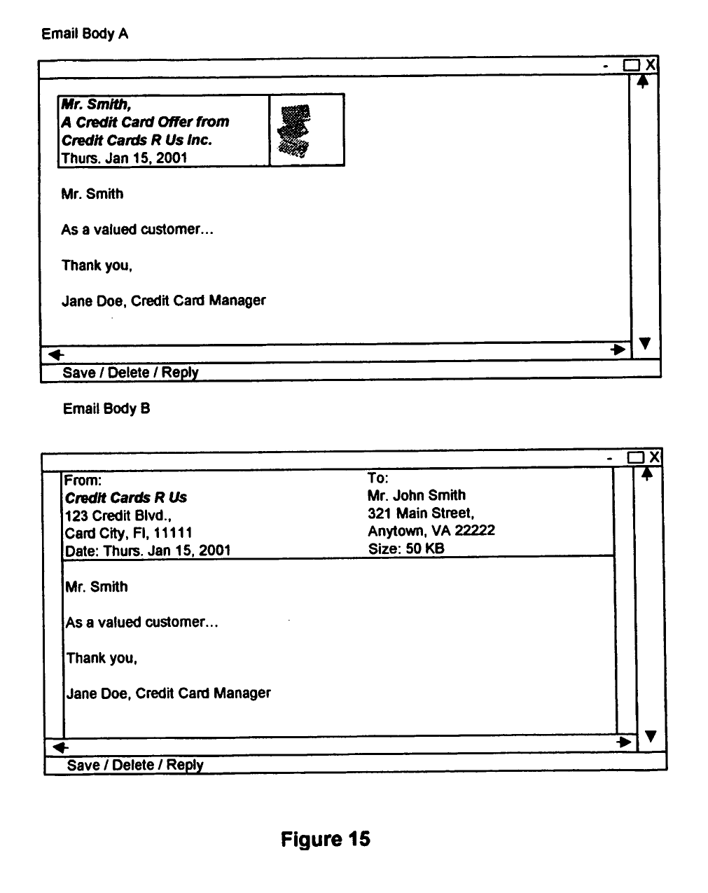

FIGS. 14 and 15.

FIG. 14 is an embodiment of the destination inbox 551, per the Email Banner™ method and system of FIG. 3. It displays the various “banners” 553 of different sizes and richness of information—some are picture only, some mix picture and graphics, etc.

555 are tabs to the other categories folders of the invention—these need not be Banner Email™ based—this embodiment has the Email Banner to be the main menu for the invention's category folders, where the subscriber is “encouraged” to interact or view the advertisement before accessing their other “bills” and “subscription” folders. 557 are the selection box, where the user may select and delete or save the advertisement.

FIG. 15 are two possible embodiments of the email body of the Email Banner; further alternatively is can display a browser window or take the user to an advertiser's web page. The Email Banner can even be a video stream.

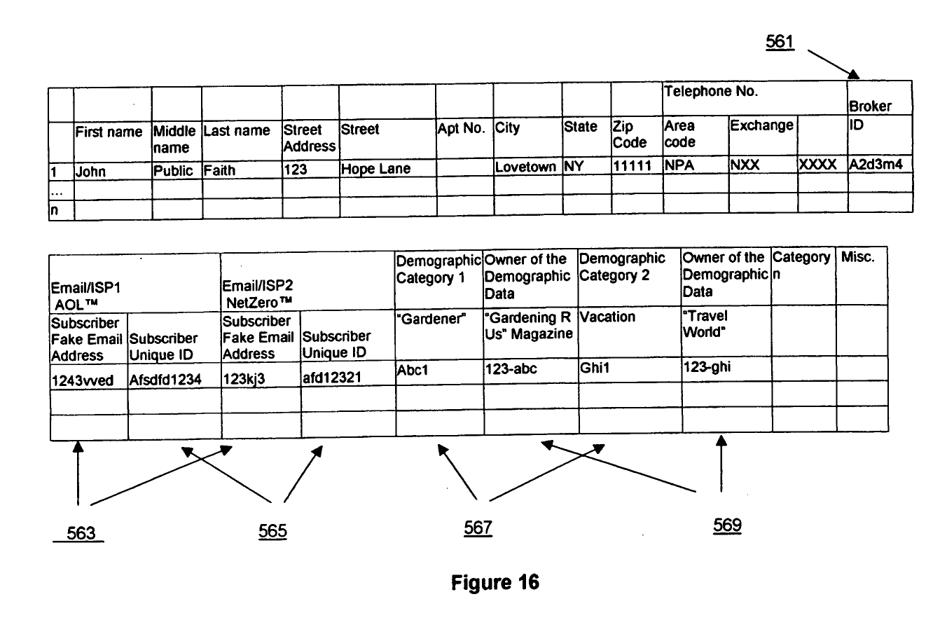

FIG. 16

An embodiment of the “reverse mapping” of demographic values to the subscriber lists of the Email and Internet service providers is provided. A mapping program takes the demographic lists of cooperating list owners and provides on-the-fly or pre-mapped data to a names and addresses list, also the subscriber lists are added to it as an option. The purpose is that an aggregate demographic profile (based on the availability of the cooperating third party demographic databases) of each subscriber can be created and the optionally the ISPs that provide service to the subject name and address. The main difference from the traditional direct marketing/mailing lists is that the traditional list or “map” the names and addresses to a demographic category and each list is generally sold/rented in its entirety (it does allow limited other demographic mapping, such as geographic data, which is a default “second demographic” value in any demographic category names and addresses list. However, with the online email marketing, the subscribers' email and IP addresses are perhaps as important as the demographic data. Thus, the invention reverse maps the various demographic profiles and values to the names and addresses in the subscriber databases of the ISPs. Some benefits of such is that a searcher can select two or more psychographic criteria, aka as “lifestyle selector”, e.g.—hobbies, recreation, lifestyle (as well as geographic and demographic)—then is able to identify the individual with all the criteria, in real time, dynamically and automatically, for example, a searcher may select “cruise vacation”, “senior citizen”, “golf” and “wine” categories/lists to be merged and only obtain the individuals that are common to all. Further, the demographic category lists are sourced and owned by separate parties; the system will track and properly attribute any fees on itemized basis to the cooperating list owners.

In USA, there are some 30,000 commercial lists available for rent. These range from psychographic and life style demographics data to SIC, etc. In one embodiment, the life style demographic data are used to create the lifestyle demographic database of the subscribers. While there are thousands of categories and lists, lifestyle category allows one to narrow the field to major categories. One leading list broker has 18 major categories: for example, “Active Travelers”—further segmented to—cruise ship vacations, travel for business, travel for pleasure/vacation, foreign travel, domestic travel, frequent flyers; “Fine Living”—cultural arts, fine arts, vacation home owners, wines; “Credit Card”—any credit card, bank, gas, Dept. stores, travel/entertainment.

FIG. 16 shows a data values where the various demographic and ISP values have been mapped and appended to a names and addresses list “data card”.

561 is the broker's or the owner of the subject database's identifier for the subject individual; 565 is the ISP's identifier for the subject individual; optionally is the ISPs desires to, then they can provide unique fake email address 565 for the subject individual, the decoding of such fake email address is only known to the ISP—or the list provider for email addresses; 567 is a demographic category associated to the subject individual; 569 is the identity for the provider or owner of the demographic category data in order that if a targeting is made based on a provided demographic value from a cooperating demographic database providers x6—then proper fee attribution can be made. The id tags serve to help the data searching and manipulation.

Per the 563 and 565, many individuals are subscriber or customer of more that one Email and Internet service provider. Thus the names and addresses list system or broker will implement rules to govern which ISP will be the preferred choice, or a prospective searcher/advertiser may make that determination.

The FIG. 16 shows two ISPs and two demographic data; however, one can see that such can include many more.

An example of using such database is that a search can search for individual interested in “gardening” and “vacation” and is able to obtain such result, select the preferred ISPs, and then the proper attribution of using the demographic data are made to the respective demographic data providers.

A variety of database servers and programs can be used to effectuate such mapping and the searching, and other data functions. Each field can be periodically updated by the respective data sources. For example, the ISP1 can update the subscriber data periodically on a monthly or quarterly basis. The original names and addresses list can be from any directory of names and addresses list.

The NPA-NXX-XXXX in the telephone number field is the current format used by the North American Telephone Numbering Plan (NANP). “The telephone numbers to which the definition of aging will apply are those numbers in the 10-digit NANP number format (NPA-NXX-XXXX) within existing geographic central office (NXX) codes . . . ” www.nanpa.com; www.atis.org.

Those skilled in the art will recognize that the methods and apparatuses of the present invention have many applications, and that the present invention is not limited to the representative examples disclosed herein. Moreover, the scope of the present invention covers conventionally known variations and modifications to the system components described herein, as would be known by those skilled in the art.

What is claimed is:

1. A method of managing emails received through a computer network, the method comprising:
receiving an email through a computer network;
determining whether the received email conforms to a predetermined code set, the code set defining the treatment of emails;
retrieving the code contained in the received email if it is determined that the received email conforms to the predetermined code set; and
taking action on the received email according to the retrieved code.

2. The method according to claim 1 wherein the retrieved code represents an instruction to highlight the email when displayed in an email list to distinguish the received email from other emails in the displayed list.

3. The method according to claim 1 wherein the retrieved code represents an instruction to route the received email to a folder different from a regular in-box folder.

4. The method according to claim 1 wherein the code set defines routing of emails to one of a plurality of predetermined categories, and the step of taking action includes:
determining the category of the received email based on the retrieved code; and
routing the received email to an email folder associated with the determined category.

5. The method according to claim 4, further comprising creating the associated folder if the associated folder does not exist.

6. The method according to claim 4, further comprising creating the associated folder if the associated folder does not exist, wherein the plurality of categories include one or more of a bills category, a subscription category, an opt-in category and an advertisement category.

7. The method according to claim 1, further comprising authenticating the sender of the received email.

8. A method of categorizing emails received through a computer network, the method comprising:
receiving an email through a computer network;
determining whether the received email conforms to a predetermined code set, the code set defining routing of emails to one of a plurality of predetermined categories;
retrieving the code included in the received email if it is determined that the received email conforms to the predetermined code set;
determining the category of the received email based on the retrieved code; and
routing the received email to an email folder associated with the determined category.

9. The method according to claim 8 wherein the retrieved code includes an instruction to highlight the email when displayed in an email list to distinguish the received email from other emails in the displayed list.

10. The method according to claim 8, further comprising creating the associated folder if the associated folder does not exist.

11. The method according to claim 8, further comprising creating the associated folder if the associated folder does not exist, wherein the plurality of categories include one or more of a bills category, a subscription category, an opt-in category and an advertisement category.

12. The method according to claim 8, further comprising authenticating the sender of the received email.

13. A method for targeting a selected group of users, the method comprising:
receiving by an Internet service provider (ISP) identification data of a plurality of individuals from a marketer;
receiving a marketing material from the marketer;
comparing the identification data of the individuals with the identification data of subscribers to the ISP to determine subscribers having matching identification data; and
sending by the ISP an email containing the marketing material to each matched subscriber.

14. A method for interacting with emails, the method comprising:
receiving one or more emails with each email having a banner portion;
receiving a request to view an email list of the received emails from a user; and
for each email in the email list, displaying the banner portion of the each email in a graphical banner format prior to the user opening the email.

15. The method according to claim 14 wherein the banner contains JAVA, XML or HTML code.

16. The method according to claim 14, further comprising:
receiving a user selection of one of the displayed emails; and
opening the selected email.

17. A method of anonymously interacting with an email sender, the method comprising:
receiving a request from a receiver to reply anonymously to a first email from a sender sent to a receiver email address;
sending a reply email to the sender using a substitute email address of the receiver, the substitute address being different from the receiver email address;
receiving a second email sent from the sender and addressed to the substitute email address in response to the reply email; and
sending the second email to the receiver with the receiver email address.
